(19) United States
(12) Patent Application Publication
(10) Pub. No.: US 2013/0054425 A1
(43) Pub. Date: Feb. 28, 2013

(54) WEB-BASED SYSTEM PERMITTING A CUSTOMER TO SHOP ONLINE FOR CLOTHES WITH THEIR OWN PICTURE

(71) Applicants: Francesco Alexander Portelos, Staten Island, NY (US); John Macari, JR., New York, NY (US)

(72) Inventors: Francesco Alexander Portelos, Staten Island, NY (US); John Macari, JR., New York, NY (US)

(21) Appl. No.: 13/593,496

(22) Filed: Aug. 23, 2012

Related U.S. Application Data
(60) Provisional application No. 61/528,638, filed on Aug. 29, 2011.

(51) Int. Cl. G06Q 30/00

(52) U.S. Cl. 705/27.2

(57) ABSTRACT

A system allows a customer to upload their face and drag it over a model's face on a clothing shopping website. The system can provide the customer with better insight on how the shirt, dress, blouse, or the like, will look in conjunction with their own face. The customer can sign up for the system, upload one or several pictures, and crop out the outline of their face. They can then click on a virtual mall to take their face to various clothing sites.

### CROSS-REFERENCE TO RELATED APPLICATION

This application claims the benefit of priority of U.S. provisional application No. 61/528,638, filed Aug. 29, 2011, the contents of which are herein incorporated by reference.

### BACKGROUND OF THE INVENTION

The present invention relates to online clothing shopping systems and, more particularly, to a web-based system where a customer shops online for clothes with their own uploaded picture.

When a customer views an article of clothing on a retail store's website, it is difficult to answer the question, “Will this look good on me?” Not only does a customer not know if the clothing will fit, but also the problem arises on which article will suit the customer's look better.

As can be seen, there is a need for a system that can allow a customer to shop for clothing online and see an image of their face wearing the clothing prior to purchase.

### SUMMARY OF THE INVENTION

In one aspect of the present invention, a method for online clothes shopping comprises uploading a photo to a clothes shopping system; cropping a face image from the photo; saving the cropped face image; selecting a link to a shopping web site; and displaying the cropped face image on the shopping web site to show clothing with the cropped face image adjacent thereto, such that it appears the cropped face image is wearing the clothing.

In another aspect of the present invention, a web-based clothing shopping system comprises an image processing system, the image processing system allowing a user to upload a photo, crop the photo to create a cropped face image, and save the cropped face image; and a shopping system, the shopping system including a link to a shopping web site, where a toolbar is displayed allowing a user to recall a saved cropped face image and display the cropped face image onto selected clothing.

These and other features, aspects and advantages of the present invention will become better understood with reference to the following drawings, description and claims.

### BRIEF DESCRIPTION OF THE DRAWINGS

FIG. 1 is a flow chart describing steps in using the clothes shopping system of the present invention;

FIG. 2 is a detailed view showing options available to a user when they select a toolbar option within the clothes shopping system of the present invention;

FIG. 3 is a front view of an uploaded photo of a user from which their face can be cropped;

FIG. 4 is a front view of the uploaded photo of FIG. 3, showing crop region control dots for selecting the user's face from the photo;

FIG. 5 is a front view of the user's face cropped from the uploaded photo of FIG. 3 and cropped by the crop region control dots shown in FIG. 4;

FIG. 6 is a screen-shot of an affiliate website having clothing offered for sale, where the user's cropped photo of FIG. 5 can be placed on one or more clothing offerings; and

FIG. 7 is a screen shot showing the user's cropped photo of FIG. 5 posted to another clothing offering.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system that allows a customer to upload their face and drag it over a model's face and/or article of clothing on a clothing shopping website. The system can provide the customer with better insight on how the shirt, dress, blouse, or the like, will look in conjunction with their own face. The customer can sign up for the system, upload one or several pictures, and crop out the outline of their face. They can then click on a virtual mall to take their face to various clothing sites.

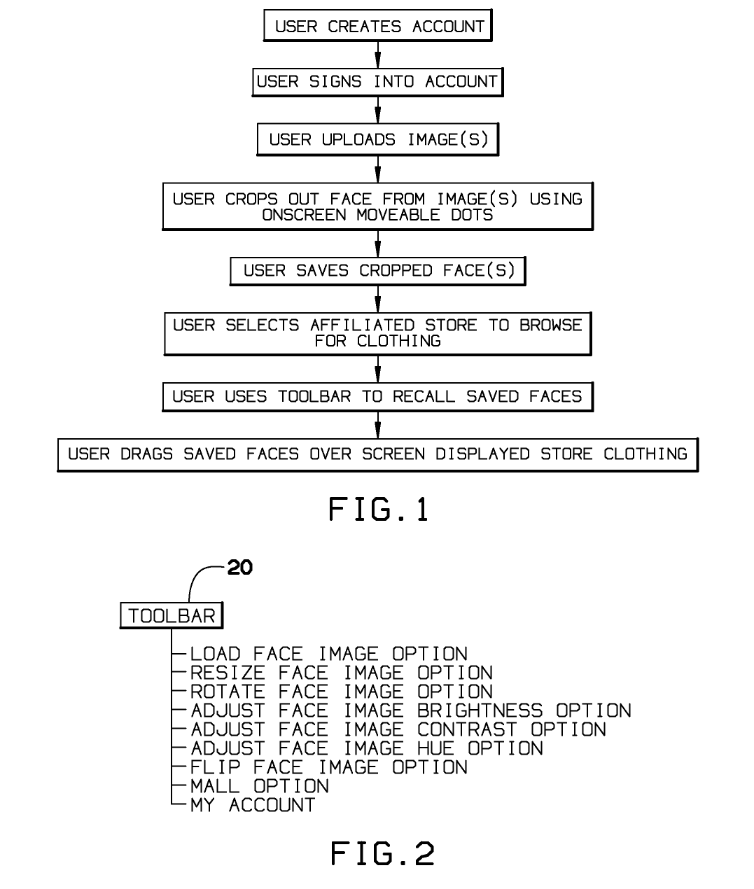

Referring to FIG. 1, a user can first create an account to access the system of the present invention. Once an account is created, the user can sign into their account. When using the system for the first time, or when desired, the user can upload on or more images that have a face shot that is desired to use further in the system. The user can crop out the face, as described below, using onscreen movable dots. Once the face is appropriately cropped, the user can preview the cropped face and save the cropped face.

The user can then select an affiliated store to browse for clothing. The system of the present invention can then run as a transparent overlay of the affiliated store's website, allowing the user to use the provided toolbar to recall a saved face and drag the selected save face over the screen displaying the store's clothing options.

Referring to FIG. 2, a toolbar 20 that displays on the affiliated store's website can include a plurality of options, such as loading a face image; resizing a face image; rotating a face image; adjusting brightness, contrast or hue; and flipping the face image. The toolbar also includes a mall option for shopping at various affiliated web sites and a My Account option.

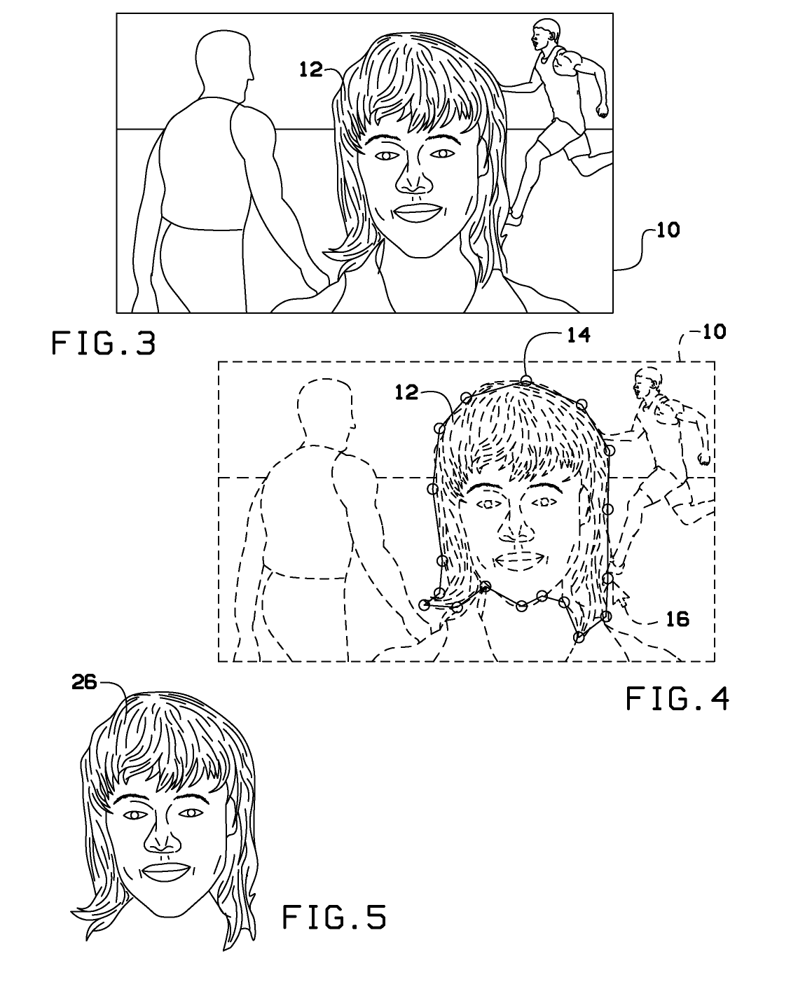

The face cropping process, as shown in FIGS. 3-5, performs various functions for obtaining a cropped face image 26 for use in the shopping process. For example, the face cropping process includes uploading a photo 10 that includes a face region 12 of the user (FIG. 3) , setting crop region control dots 14 about the face region 12 with a mouse cursor (or finger for mobile devices) 16 (FIG. 4), for example, and a obtaining the cropped face image 26 (FIG. 5).

The face cropping process can be done by various software processes. For example, Adobe Flash picture cropping can be used to upload and crop the face region from a picture. The software process for the face cropping process can be disposed on a user's computer system, can be part of a web-interface, can be disposed on a cloud system or the like. The software can be run on the user's computer or may be run on a server computer and controlled by the user. In some embodiments, the face cropping process can recognize a face and automatically crop the face image, where the user can have the option to touch-up the cropping to their desires. Various automatic and manual settings can be provided as may be known in the art to assist the user with face cropping and adjusting the color, sharpness, hue, contrast, and the like.

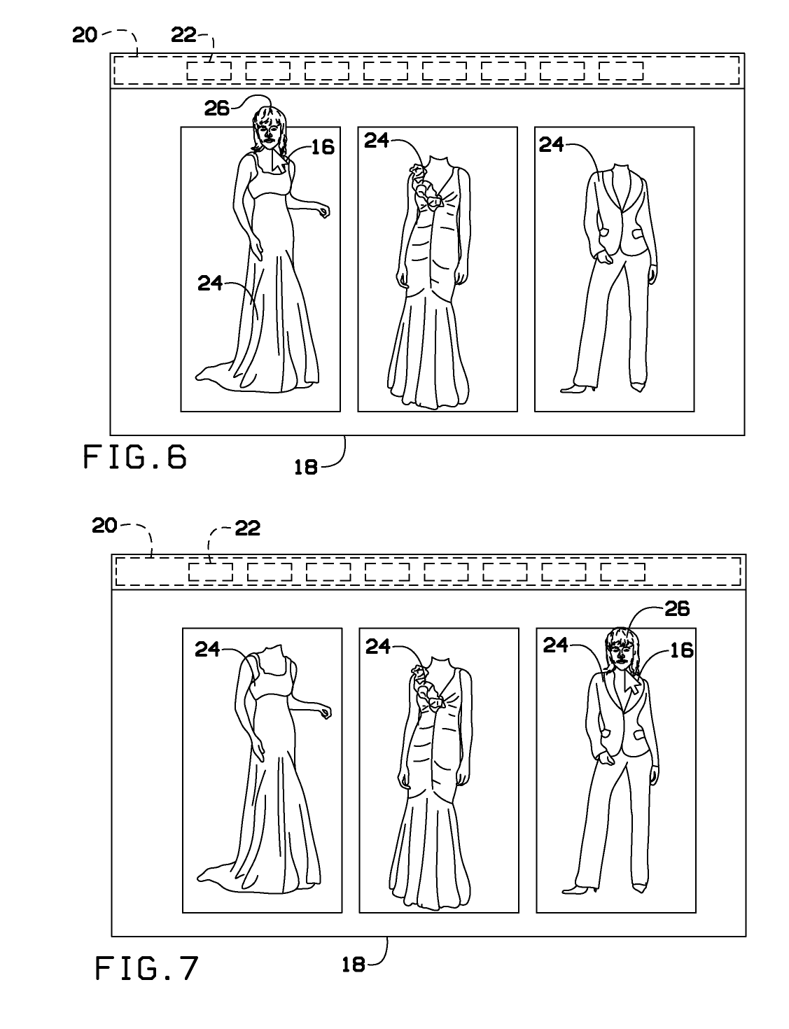

Referring now to FIGS. 6 and 7, a user can click on a shopping site and have toolbar 20, with one or more toolbar control buttons 22 appear on an exemplary website apparel display 24. The shopping process can use, for example, a Jquery transparency overlay that can show the uploaded face and the retail store's site simultaneously. This gives the illusion that the customer is trying on the clothes from the site. The transparent overlay can provide the toolbar 20 and the cropped face image 26. In some embodiments, a user may have the option to bring in multiple cropped face images 26, which may be the same or different.

In summary, to use the system of the present invention, a user can go to a website, such as www.faceshop.me to create an account, upload a picture, crop the facial outline, and click on shopping sites. Once a picture is included in the account, the user can have the option to upload additional pictures, or simply click on a shopping site to start shopping. The system's menu can appear out of the way, for example, on top, and the customer can shop as they normally would on the store's website. When the customer comes across clothing they are interested in, they call upon their cropped face by selecting the appropriate control button 22 from the tool bar 20. The cropped face 26 can appear on the site and the user can resize it as needed and drag it over the model's face or to the neckline of the clothing (if not shown on a model). The user can change various aspects of the picture (tone, color, hue, contrast, and the like) to match the model's picture, for example.

While the above is described as a system for shopping for clothing, the system can be used on other web sites. Perhaps, for enjoyment, one would want to have their face placed over a celebrity, athlete or political figure, for example.

It should be understood, of course, that the foregoing relates to exemplary embodiments of the invention and that modifications may be made without departing from the spirit and scope of the invention as set forth in the following claims.

What is claimed is:

1. A method for online clothes shopping comprising:
uploading a photo to a clothes shopping system;
cropping a face image from the photo;
saving the cropped face image;
selecting a link to a shopping web site; and
displaying the cropped face image on the shopping web site to show clothing with the cropped face image adjacent thereto, such that it appears the cropped face image is wearing the clothing.

2. The method of claim 1, further comprising moving a plurality of crop region control dots to select the face image from the photo.

3. The method of claim 1, further comprising providing a user sign-in screen for a user to sign into the clothes shopping system.

4. The method of claim 1, further comprising displaying a toolbar on the shopping web site, the toolbar having options to display the cropped face image on the shopping web site.

5. The method of claim 4, wherein the toolbar further includes options for loading a face image; saving a face image; resizing a face image; rotating a face image; adjusting brightness, contrast or hue; and flipping the face image.

6. The method of claim 4, wherein the toolbar is displayed on a top portion of the shopping web site, out of the way of a user shopping on the shopping web site.

7. A web-based clothing shopping system comprising:
an image processing system, the image processing system allowing a user to upload a photo, crop the photo to create a cropped face image, and save the cropped face image; and
a shopping system, the shopping system including a link to a shopping web site, where a toolbar is displayed allowing a user to recall a saved cropped face image and display the cropped face image onto selected clothing.

8. The web-based clothing shopping system of claim 7, wherein the image processing system includes a photo cropping subsystem providing the user with a plurality of crop region control dots to select a face image from the photo.

9. The web-based clothing shopping system of claim 7, further comprising a sign-in system, permitting a user to register for use of the system and for future sign-in into the system to recall saved cropped face images.

10. The web-based clothing shopping system of claim 7, wherein the toolbar further includes options for loading a face image; saving a face image; resizing a face image; rotating a face image; adjusting brightness, contrast or hue; and flipping the face image.
